(19) United States
(12) Patent Application Publication
(10) Pub. No.: US 2014/0042684 A1
(43) Pub. Date: Feb. 13, 2014

(54) SCREW INSTALLATION DEVICE

(71) Applicants: ASKEY TECHNOLOGY (JIANGSU) LTD., Jiangsu Province (CN); ASKEY COMPUTER CORPORATION, New Taipei City (TW)

(72) Inventors: Bin GUO, Jiangsu Province (CN); Hon-Man LUI, New Taipei City (TW)

(73) Assignees: ASKEY COMPUTER CORPORATION, New Taipei City (TW); ASKEY TECHNOLOGY (JIANGSU) LTD., Jiangsu Province (CN)

(21) Appl. No.: 13/687,943

(22) Filed: Nov. 28, 2012

(30) Foreign Application Priority Data
Aug. 13, 2012 (TW) 101215559

(51) Int. Cl. B23Q 7/00

(52) U.S. Cl. CPC B23Q 7/00
USPC 269/289 R

(57) ABSTRACT

A screw installation device is provided, including a base having a tray for carrying a circuit board, a vertical holder vertically disposed on the base, an accommodating unit, an elastic unit, and a double-link horizontal holder having one end connected to the vertical holder and the other end connected to the accommodating unit for accommodating an electric screwdriver. The double-link horizontal holder adjusts the position of the accommodating unit such that the electric screwdriver is movable with respect to the tray in both vertical and horizontal directions. The elastic unit is mounted on the double-link horizontal holder for providing the accommodating unit with an upward elastic force after a downward force is exerted on the electric screwdriver for installing the screw. The present invention eliminates the adverse effects such as reduction in service life and scratching of the product as a result of slippage of the electric screwdriver head.

### BACKGROUND OF THE INVENTION

1. Field of the Invention

The present invention relates to product assembly techniques, and, more particularly, to a screw installation device for component assembly.

2. Description of Related Art

FIG. 1 is a diagram depicting a holder 11 for a conventional electric screwdriver 10. A traditional way of fitting screws onto a circuit board is done by manually operating the electric screwdriver 10. However, when the electric screwdriver 10 is held manually to perform such a process, there is no supporting tool to hold a user's hand stably in place, which may result in slippage of the heads of the electric screwdriver 10 and the screw, insufficient tightening of the screw, and scratching of the surface of the circuit board.

In addition, electric wires 13 of the electric screwdriver 10 are also prone to winding during the process, thus hindering the normal operations of the operators.

It can be seen from the above that the traditional approach for fitting screws onto the circuit board is not only laborious, but may present problems such as slippage, and thus lowers production efficiency.

Therefore, there is a need for a screw installation device that eliminates slippage and scratching of the surface of the circuit board while saving time and labor and increasing production efficiency.

### SUMMARY OF THE INVENTION

An objective of the present invention is to provide a screw installation device that eliminates slippage of the electric screwdriver head and scratching of the surface of the circuit board.

Another objective of the present invention is to provide a screw installation device that saves time and labor and increases production efficiency.

In accordance with the above and other objectives, the present invention provides a screw installation device for fitting a screw onto a circuit board, which includes: a base including a tray for carrying the circuit board; a vertical holder vertically disposed on the base; a double-link horizontal holder with one end connected to the vertical holder and the other end connected to an accommodating unit for accommodating an electric screwdriver, the double-link horizontal holder adjusting the position of the accommodating unit such that the electric screwdriver is movable with respect to the tray in both vertical and horizontal directions; and an elastic unit mounted on the double-link horizontal holder and providing the accommodating unit with an upward elastic force after a downward force is exerted on the electric screwdriver for installing the screw.

In an embodiment, the accommodating unit further includes a tubular body for receiving electric wires of the electric screwdriver.

In an embodiment, the double-link horizontal holder further includes an upper link connected to one end of the elastic unit and a lower link connected to the other end of the elastic unit.

In an embodiment, an adjustment unit is further provided on the upper link of the double-link horizontal holder for adjusting the upward elastic force of the elastic unit.

In an embodiment, the double-link horizontal holder is movable with respect to the vertical holder in the vertical direction, and the double-link horizontal holder is movable with respect to the tray in the horizontal direction.

Compared to the prior art, the screw installation device of the present invention helps the operators in controlling the position of the electric screwdriver and provides an upward elastic force to ensure that the electric screwdriver follows a vertical trajectory in fitting screws onto the circuit board. This effectively improves the abnormal circumstances such as slippage of the electric screwdriver head and scratching of the surface of the product during the screw installation process, while saving time and increasing production efficiency.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram depicting a holder for a conventional electric screwdriver;

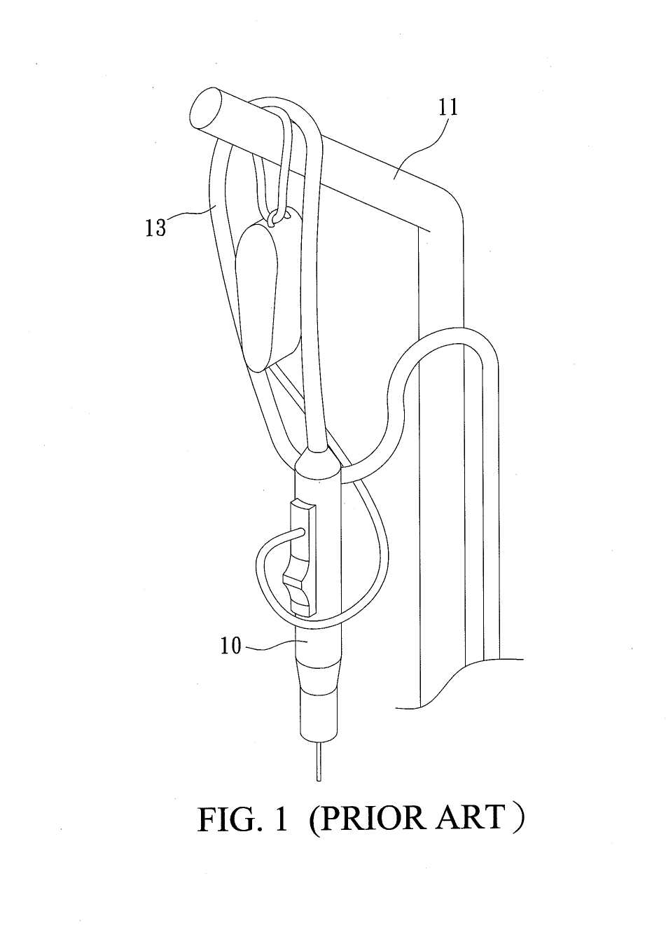

FIG. 2 is a schematic diagram depicting a screw installation device according to the present invention; and

FIG. 3 is a schematic diagram depicting a double-link horizontal holder of the screw installation device according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

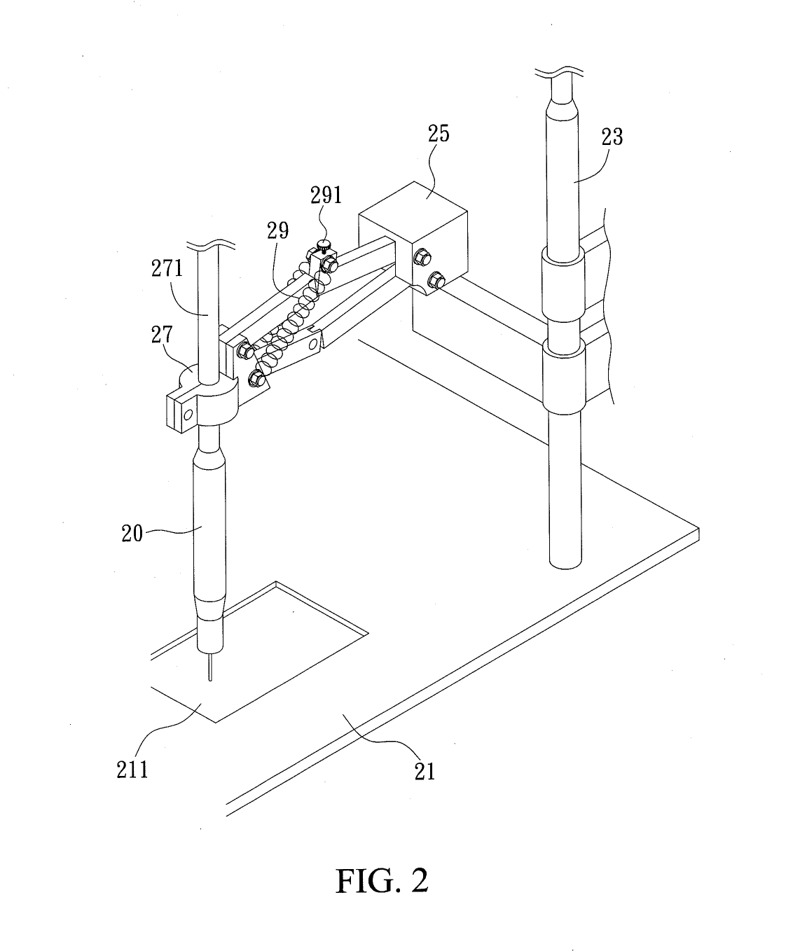

A screw installation device provided according the present invention can be used for fitting screws onto a circuit board. Referring to FIG. 2, a schematic diagram depicting the screw installation device according to the present invention is shown.

As shown in FIG. 2, the screw installation device includes a base 21, a vertical holder 23, a double-link horizontal holder 25, an accommodating unit 27, and an elastic unit 29. The base 21 is provided with a tray 211 thereon. The tray 211 is used for carrying a circuit board to be fitted with screws.

The vertical holder 23 is vertically disposed on the base 21. The tray 211 and the vertical holder 23 are fixed on different locations of the base 21.

The double-link horizontal holder 25 has one end connected to the vertical holder 23 and the other end connected to the accommodating unit 27, and is movable relative to the vertical holder 23 in the vertical direction for adjustment of the vertical distance between the double-link horizontal holder 25 and the tray 211, or is movable with respect to the tray 211 in the horizontal direction. In an embodiment, the double-link horizontal holder 25 is designed with two-end movable arms in order to facilitate the horizontal position adjustment towards the front, the back, the left and the right.

The accommodating unit 27 is located at the other end of the double-link horizontal holder 25. The accommodating unit 27 is used for accommodating an electric screwdriver 20, wherein the double-link horizontal holder 25 is used for adjusting the accommodating unit 27, so that the electric screwdriver 20 can be moved with respect to the tray 211 in both the horizontal and vertical directions, and so that the electric screwdriver 20 is placed on top of the tray 211. In an embodiment, the accommodating unit 27 further includes a tubular body 271 for receiving the electric wires of the screwdriver 20 in order to prevent winding of the electrical wires from affecting the operations during the screw installation process.

The elastic unit 29 is mounted on the double-link horizontal holder 25 for providing the accommodating unit 27 with an upward elastic force, such that after a downward pressure is exerted on the electric screwdriver 20 to fit a screw onto the circuit board, the accommodating unit 27 is provided with the upward elastic force.

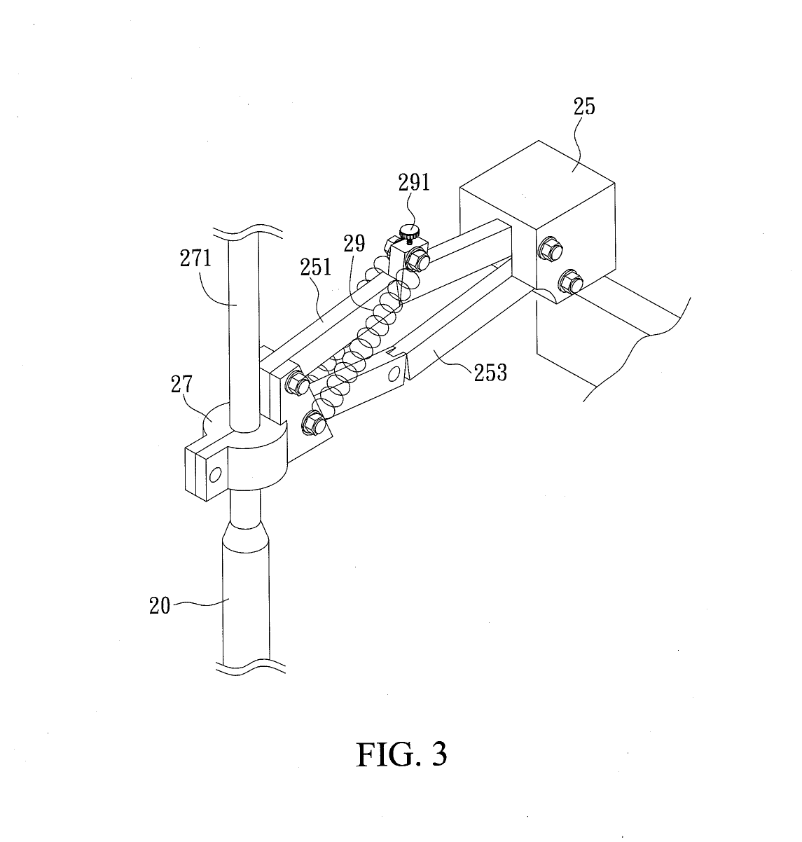

Referring to FIG. 3, a schematic diagram depicting a more detailed view of the double-link horizontal holder of the screw installation device according to the present invention is shown. In an embodiment, the double-link horizontal holder 25 further includes an upper link 251 connected to one end of the elastic 29 and a lower link 253 connected to the other end of the elastic unit 29. An adjustment unit 291 is further provided on the upper link 251 of the double-link horizontal holder 25. The adjustment unit 291 is used for adjusting the upward elastic force of the elastic unit 29.

Refer to FIGS. 2 and 3, in practice an operator can simply adjust the distance between the electric screwdriver 20 and the tray 211 on the circuit board by the vertical holder 23, and the double-link horizontal holder 25, and after the position is adjusted, a downward force is applied to the electric screwdriver 20, so that the electric screwdriver 20 can install a screw onto the circuit board along the vertical trajectory. Upon installation of the screw, the electric screwdriver 20 is forced back (i.e., moving upwards) to its original position as a result of the elastic unit 29.

In summary, the screw installation device according to the present invention helps in securing the electric screwdriver and the position of its electric wires, thereby effectively preventing electric screwdriver head from slipping and damaging the surface of the product as well as preventing the winding of the electric wires from affecting the operations during the screw installation process. It is easy to operate and increases work efficiency, thus saving time and increasing production efficiency.

The above embodiment is only used to illustrate the principles of the present invention, and it should not be construed as to limit the present invention in any way. The above embodiment can be modified by those with ordinary skill in the art without departing from the scope of the present invention as defined in the following appended claims.

What is claimed is:

1. A screw installation device for fitting a screw onto a circuit board, comprising:
a base including a tray for carrying the circuit board;
a vertical holder vertically disposed on the base;
a double-link horizontal holder with one end connected to the vertical holder and the other end connected to an accommodating unit for accommodating an electric screwdriver, the double-link horizontal holder adjusting the position of the accommodating unit such that the electric screwdriver is movable with respect to the tray in both vertical and horizontal directions; and
an elastic unit mounted on the double-link horizontal holder and providing the accommodating unit with an upward elastic force after a downward force is exerted on the electric screwdriver for installing the screw.

2. The screw installation device of claim 1, wherein the accommodating unit further includes a tubular body for receiving electric wires of the electric screwdriver.

3. The screw installation device of claim 1, wherein the double-link horizontal holder further includes an upper link connected to one end of the elastic unit and a lower link connected to the other end of the elastic unit.

4. The screw installation device of claim 3, further comprising an adjustment unit provided on the upper link of the double-link horizontal holder and adjusting the upward elastic force of the elastic unit.

5. The screw installation device of claim 1, wherein the double-link horizontal holder is movable with respect to the vertical holder in the vertical direction, and the double-link horizontal holder is movable with respect to the tray in the horizontal direction.
